(19) United States
(12) Patent Application Publication
(10) Pub. No.: US 2002/0142198 A1
(43) Pub. Date: Oct. 3, 2002

(54) Process for air enrichment in producing hydrogen for use with fuel cells

(76) Inventors: Gavin P. Towler, Barrington, IL (US); Kishore J. Doshi, Lake Zurich, IL (US)

Correspondence Address: JOHN G. TOLOMEI, UOP LLC, PATENT DEPARTMENT, 25 EAST ALGONQUIN ROAD, P.O. BOX 5017, DES PLAINES, IL, 60017-5017, US

(21) Appl. No.: 09/733,362

(22) Filed: Dec. 8, 2000

(51) Int. Cl. H01M 8/06

(52) U.S. Cl. 429/17; 429/20

(57) ABSTRACT

Hydrogen generation and fuel cell operation are integrated through the use of a fuel processor or hydrogen generation zone which comprises a pre-reforming zone, a partial oxidation zone, a reforming zone, a water gas shift zone and a preferential oxidation zone. According to the present invention, an oxygen-enriched stream is provided to the fuel processor and to the fuel cell from the adsorption effluent withdrawn from an adsorption zone. The oxygen-enriched stream is depleted in nitrogen which improved the efficiency of the fuel processor and the fuel cell by reducing nitrogen dilution. A further advantage resulted in fuel processor/fuel cell systems which burn the anode waste gas in a combustion zone to provide heat to the fuel processor zone. By diluting the anode waste gas with an oxygen-reduced gas, it is possible to maintain the combustion temperature in the convection range and reduce or eliminate the amount of excess air employed in the combustion zone

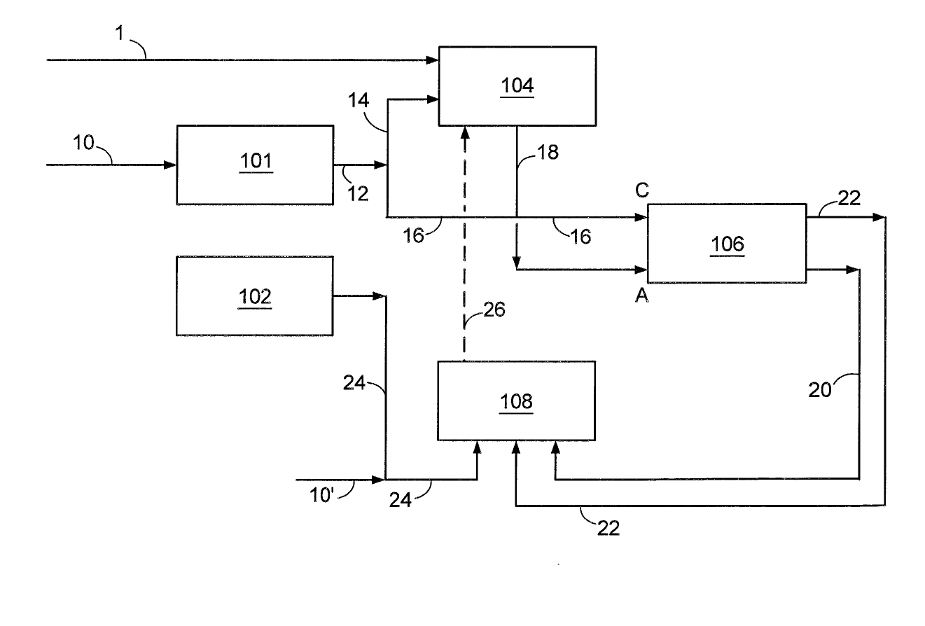

### FIELD OF THE INVENTION

The present invention relates to a process for enriching air for use in a hydrogen generating process and, more particularly, the present process relates to a process for enriching air and distributing air in integrated small scale fuel processors in conjunction with a fuel cell electric power generation system.

### BACKGROUND OF THE INVENTION

The need for an efficient, non-polluting power source for vehicles and stationary power plants in urban environments has resulted in increased attention to the option of fuel-cell systems of high efficiency and low emissions. Hydrogen is the most suitable fuel for a fuel cell system, providing the highest conversion efficiency for fuel-on-board-to-electric-power for vehicular systems and generating zero emissions since water is the only product of the hydrogen/air fuel cell process. In the hydrogen/air fuel cell, the processes at the anode and cathode, respectively, are:

H₂=2H++2e (anode process) (1)

and,

O₂+4e+4H+=2H₂O (cathode process) (2)

Hydrogen fuel could be carried on board the vehicle or stored as either neat hydrogen, in the form of pressurized gas or cryogenically stored liquid, or in the form of a more ordinary liquid fuel, such as methanol or liquid hydrocarbon, which needs to be processed/converted on board the vehicle to a mixture of hydrogen and CO₂. Because hydrogen is difficult or expensive to store, it likely that fuel processors will be employed to convert hydrocarbons or oxygenates to hydrogen for vehicle and for stationary power generation systems in an integrated fuel processor/fuel cell system Hydrogen may be produced from hydrocarbons or oxygenates in a fuel processor zone which generally consists of a steam reforming zone or a steam reforming zone and a partial oxidation zone (secondary reforming )to convert the hydrocarbon or oxygenate feed stream into a synthesis gas stream. Modifications of the simple steam reforming processes have been proposed to improve the operation of the steam reforming process. In particular, there have been suggestions for improving the energy efficiency of such processes in which the heat available from the products of a secondary reforming step is utilized for other purposes within the synthesis gas production process. For example, processes are described in U.S. Pat. No. 4,479,925 in which heat from the products of a secondary reformer is used to provide heat to a primary reformer.

The reforming reaction is expressed by the following formula:

CH₄+2H₂O→4H₂+CO₂

where the reaction in the reformer and the reaction in the shift converter are respectively expressed by the following simplified formulae (3) and (4):

CH₄+H₂O→CO+3H₂ (3)

CO+H₂O→H₂+CO₂ (4)

Because formula (3) will produce CO and CO can be detrimental to the operation of the fuel cell, a series of CO removal steps may be included in a fuel processor zone. One of the most common CO removal or hydrogen purification steps is a water gas shift conversion zone. In the water gas shift conversion zone which typically follows a reforming step, formula (4) is representative of the major reaction.

If it is required to reduce the CO concentration to very low levels, such as less than 50 ppm mol, or less than 10 ppm mol, a preferential oxidation step may follow the water gas shift step. In the preferential oxidation step, the hydrogen fuel stream at effective conditions is contacted with a selective oxidation catalyst in the presence of an oxygen containing stream to selectively oxidize carbon monoxide to carbon dioxide and produce a fuel stream comprising between about 10 and 50 ppm-mol carbon monoxide. The thus purified fuel stream is passed to an anode side of the fuel cell and an air stream is passed to the cathode side of the fuel cell.

When a partial oxidation zone is employed in the fuel processor and air is supplied to the partial oxidation zone, the oxygen portion of the air stream is converted, nitrogen is released and can build up in the system, reducing efficiency and diluting the fuel stream to the fuel cell. U.S. Pat. No. 5,925,322 discloses the use of a non-cryogenic oxygen-enrichment means such as a temperature swing adsorption process to enrich the air stream passed to the partial oxidation zone or a fuel cell zone, and heat produced in the partial oxidation zone or the fuel cell zone is employed to provide heat to regenerate the temperature swing adsorption zone.

U.S. Pat. No. 6,007,930 discloses a method for initating a fuel cell system by directly introducing an oxygen-containing gas to a fuel cell stack to overcome the problem of providing a sufficient amount of power to initially start an air compressor According to U.S. Pat. No. 6,007,930, on the oxygen-containing gas is introduced to the fuel cell stack to provide sufficient electrical power to start a high voltage air compressor. The use of a filter to provide oxygen-enriched air during startup is disclosed. After the air compressor is switched on, the introduction of stored gas is terminated and the gas storage system is replenished during the operation of the fuel cell.

U.S. Pat. No. 6,106,963 to Nitta et al. discloses the use of an oxygen enriched stream to improve the operation of a fuel cell. U.S. Pat. No. 6,106,963 discloses the use of a magnetic field device to separate oxygen from an air stream to provide the oxygen enriched stream for the fuel cell.

It is an objective of the present invention to solve some of the problems associated with small-scale systems for producing hydrogen for a fuel cell, to provide simplified methods for producing hydrogen for a fuel cell, to provide simple and efficient methods for controlling the hydrogen generation system associated with a fuel cell, and to provide an apparatus for the generation of hydrogen that permits the reduction in scale of hydrogen generation facilities without a corresponding loss of efficiency. It is an objective of the present invention to provide a process for using the anode waste gas as the primary fuel for the generation of hydrogen for a fuel cell wherein the fluctuations in the anode waste gas flow rate and heating value are managed in the process to maintain a high overall energy efficiency.

In the operation of an integrated fuel processor/ fuel cell system one of the major problems is avoiding large temperature swings which can shorten the useful life of the equipment.

### SUMMARY OF THE INVENTION

The present invention provides a process for the generation of electric power from a fuel processor/fuel cell system. According to the present invention, an oxygen-enriched stream is provided to the fuel processor and to the fuel cell from the adsorption effluent withdrawn from an adsorption zone. The oxygen-enriched stream is depleted in nitrogen relative to air which improved the efficiency of the fuel processor and the fuel cell by reducing nitrogen dilution. A further advantage resulted in fuel processor/fuel cell systems which burn the anode waste gas in a combustion zone to provide heat to the fuel processor zone. By diluting the anode waste gas with an oxygen-reduced gas, it is possible to maintain the combustion temperature in the convection range and reduce or eliminate the amount of excess air employed in the combustion zone, thereby reducing the power consumption required to compress air required for combustion and for temperature control of the combustion zone. An oxygen-depleted desorption effluent stream is withdrawn from the adsorption zone during a desorption step and employed to maintain a combustion zone at a temperature in the convection range in providing heat to the fuel processor zone. By alternating or cycling at least two adsorption zones between an adsorption step and a desorption step, a continuous supply of the oxygen-enriched stream and the oxygen-depleted stream can be supplied to the integrated fuel processor/fuel cell system. The invention provides significant savings by reducing the size of the blower supplying excess air for temperature control in the process. Regeneration of the adsorption zones can be accomplished by any means such as pressure, temperature, or vacuum swing adsorption

In one embodiment, the invention is a process for the generation of electricity from a fuel cell. The process comprises passing a fuel stream admixed with a first oxygen-enriched stream to a conversion zone comprising a partial oxidation reactor and therein converting at least a portion of the fuel stream to provide a reformate stream comprising hydrogen The reformate stream is passed to an anode side of a fuel cell zone, having a cathode side and the anode side. A second oxygen-enriched stream is passed to the cathode side to produce electricity and an anode waste stream and a cathode waste gas stream are withdrawn. At least a portion of the anode waste gas stream is combusted in the presence of an oxygen-depleted stream in a combustion zone to produce a flue gas stream at a combustion zone temperature to at least partially heat the conversion zone An air stream is passed to a first adsorption bed in an adsorption zone comprising at least two adsorption beds. The adsorption beds contain a nitrogen selective adsorbent. The first bed undergoes an adsorption step to provide an adsorption effluent stream and at least a portion of the adsorption effluent stream provides the first and second oxygen-enriched streams. At least one other adsorption bed is regenerated in the adsorption zone to provide a desorption effluent stream. At least a portion of the desorption effluent stream is passed to the combustion zone as the oxygen-depleted stream to maintain the combustion zone less than about 750° C.

In another embodiment, the present invention is a process for the generation of electricity from a fuel cell. A steam stream is admixed with a feed stream to provide a feed admixture. The feed admixture is passed to a pre-reforming zone which is in indirect contact with a first heat exchange zone to adjust the feed admixture to effective pre-reforming conditions and to at least partially convert the feed stream to a pre-reformed stream which comprises hydrogen, carbon monoxide, carbon dioxide, and water. The pre-reformed stream and a first oxygen-enriched stream are passed to a conversion zone comprising a partial oxidation zone and a steam reforming zone to convert at least a portion of the pre-reformed stream to provide a reformate stream enriched in hydrogen relative to the pre-reformed stream comprising hydrogen, carbon monoxide, carbon dioxide, and water. The reformate stream is passed to an anode side of a fuel cell zone, having a cathode side and the anode side and a second oxygen-enriched stream is passed to the cathode side to generate electricity. An anode waste gas is withdrawn from the anode side and a cathode waste gas from the cathode side of the fuel cell zone. An air stream is passed to a first adsorption zone of at least two adsorbent beds. Each of the adsorbent beds contains a nitrogen selective adsorbent. An adsorbent effluent stream enriched in oxygen relative to the air stream is withdrawn. A first portion of the adsorption effluent stream is passed to the conversion zone as the first oxygen-enriched stream and a second portion of the adsorption effluent stream is passed to the fuel cell zone as the second oxygen-enriched stream. At least a portion of the anode waste gas stream and an oxygen-depleted stream are combusted in a combustion zone to indirectly supply heat to the conversion zone. A second adsorbent bed is regenerated to remove previously adsorbed nitrogen to provide a desorption effluent stream depleted in oxygen relative to the air stream, and at least a portion of the desorption effluent stream is passed to the combustion zone as the oxygen-depleted stream.

In a still further embodiment, the present invention is a process for the enrichment of air supplied to an integrated fuel processor and fuel cell system comprising a fuel processor zone and a fuel cell zone. In an adsorption step, an air stream is passed to a first adsorption zone of at least two adsorbent beds. Each of the adsorbent beds contains a nitrogen selective adsorbent to adsorb nitrogen. An adsorption effluent enriched in oxygen relative to the air stream is recovered. A first portion of the adsorption effluent stream is passed to a partial oxidation zone of the integrated fuel processor and fuel cell system to produce a fuel stream comprising hydrogen in the fuel processor. A second portion of the adsorption effluent stream is passed to a fuel cell zone having an anode side and a cathode side and a cathode waste gas stream is recovered. The fuel stream is passed to the anode side of the fuel cell zone to convert the fuel stream to electric power and an anode waste gas comprising hydrogen being depleted in hydrogen relative to the fuel stream is recovered. A second adsorbent bed is desorbed in a desorption step. The second adsorbent bed comprising previously adsorbed nitrogen provides a desorption effluent enriched in nitrogen. The desorption effluent and at least a portion of the anode waste gas stream are combusted in a combustion zone to produce a flue gas stream at a combustion temperature less than about 750° C. to indirectly provide heat to a conversion zone in the fuel processor zone, The first and second adsorption zones are alternated between the adsorption and desorption steps to provide a continuous process.

### BRIEF DESCRIPTION OF THE DRAWING

The drawing is a schematic process flow diagram of the process of the present invention.

### DETAILED DESCRIPTION OF THE INVENTION

The process of the current invention uses a hydrocarbon stream such as natural gas, liquefied petroleum gas (LPG), butanes, gasoline, oxygenates, biogas, or naphtha (a gasoline boiling range material) as a feedstock. Natural gas and similar hydrocarbon streams generally contain impurities such as sulfur in the form of hydrogen sulfide, mercaptans, and sulfur oxides which must be removed prior to introducing the feedstock to the steam reforming zone. The removal of sulfur from the hydrocarbon feedstock may be accomplished by any conventional means including adsorption, chemisorption, and catalytic desulfurization. Generally, the type of pre-processing module for the hydrocarbon feedstock before it is charged to the fuel processor will depend on the character or type of hydrocarbon feedstock. A natural gas stream will generally contain small amounts of sulfur as hydrogen sulfide. Hydrogen sulfide in natural gas can be removed by contacting the natural gas stream with a chemisorbent such as zinc oxide in a fixed bed desulfurization zone. LPG, which comprises propane, butane, or mixtures thereof, generally contains very little sulfur and can be processed directly by the fuel processor, although the use of a guard bed of containing an adsorbent or a chemisorbent to protect the catalyst in the fuel processor may be included and some pressure moderating device such as a valve is required to deliver the LPG to the fuel processor. The pre-processing module, or pre-processor for a naphtha stream requires multi-stage treatment. Naphtha may have impurities such as sulfur as mercaptan sulfur, chemically combined sulfur (such as sulfides and disulfides), elemental sulfur, and hydrogen sulfide. In order to remove these sulfur impurities from the naphtha stream a combination of hydrodesulfurization in the presence of hydrogen over a desulfurization catalyst containing cobalt and molybdenum on a metal oxide base to convert the sulfur species to hydrogen sulfide, and a second stage to remove the hydrogen sulfide are required. Although any conventional hydrocarbon desulfurization catalyst may be used in the hydrodesulfurization zone, catalysts containing cobalt and molybdenum are preferred. In order to reduce the overall size of the hydrogen generation equipment, chemisorption with a material such as zinc oxide is preferred for removal of hydrogen sulfide. The chemisorption or hydrodesulfurization based desulfurization operations will generally take place at effective desulfurization conditions including a desulfurization pressure of between about 100 to about 1000 kPa. Preferably the desulfurization operation is carried out at a desulfurization pressure of between 200 and 300 kPa. Preferably the desulfurization operation is carried out at a desulfurization temperature less than about 300° C., and more preferably the desulfurization operation is carried out at a desulfurization temperature between about 500 and about 300° C. Preferably the concentration of sulfur in the desulfurized feedstock will be less than about 10 ppm-wt, and more preferably the concentration of sulfur in the desulfurized feedstock will be less than about 1 ppm-wt.

Water is required by the steam reforming process for use as a reactant and as a cooling medium. In addition for some types of fuel cells, the hydrogen product must be delivered to the fuel cell as a wet gas. This is particularly true with PEM fuel cells, wherein the humidity of the hydrogen product stream is controlled to avoid drying out the PEM membrane in the fuel cell. The water used in the steam reforming process preferably is deionized to remove dissolved metals and anions. Metals which could be harmful to catalysts include sodium, calcium, lead, copper, and arsenic. Anions such as chloride ions should be reduced or removed from water. Removal of these cations and anions are required to prevent pre-mature deactivation of the steam reforming catalyst or other catalytic materials contained in the fuel cell such as the water gas shift catalyst or the carbon monoxide oxidation catalyst in a carbon monoxide reduction zone. The deionization of the water to be used in the process may be accomplished by any conventional means.

One of the problems addressed by the present invention is the supply of heat to a steam reforming reaction which will convert hydrocarbon, or alcohol to hydrogen and oxides of carbon in the presence of water or steam over a reforming catalyst. Alcohols and other oxygen-containing hydrocarbons are easier to reform and generally can be reformed at relatively low reforming temperatures. However, hydrocarbons require a higher heat input. Prior to the process of the present invention, attempts were made to transfer heat in the radiant and the convection range of heat transfer. Unfortunately, this requires the use of high temperature radiant heat transfer zones and correspondingly exotic metallurgy to provide sufficient heat to the reforming reaction at an acceptable heating rate. In the present scheme, the feedstock is first pre-reformed at a moderate pre-reforming temperature of less than about 700° C., and the pre-reformed effluent is subjected to a partial oxidation step. The heat generated in the exothermic partial oxidation step can provide the heat to the endothermic reforming step if the two steps occur in close proximity to each other, and independent of other heat integration within the integrated process of hydrogen generation and fuel cell operation. In this manner the partial oxidation zone can provide heat at high temperatures (i.e., greater than about 700° C.). By the use of the pre-reforming zone and the partial oxidation zone, it is believed that the reforming temperature can now be lowered from the high temperature to a moderate temperature range (below about 700° C.) where exotic metallurgy is not required, or to a range wherein a portion of the reforming reaction heat may be supplied by other heat sources within the overall process Thus, by this rearrangement, the reforming step becomes independent of high temperature process heat integration and can be operated either in the radiant or in the convection range in close proximity to the partial oxidation reaction. The reforming reaction can also take place without the use of exotic metallurgy. For example, the heat required by the pre-reforming step can be supplied by indirect heat exchange within the overall process. Heat required for the pre-reforming step can be provided by heat from the exothermic water gas shift reaction step, or heat for the reforming process can be provided by the heat of combustion of waste gases from the fuel cell, or a combination thereof. preferably, the heat for the pre-reforming step is supplied by indirect heat exchange with flue gases from the combustion of anode waste gas from the fuel cell anode electrode.

The pre-processed feedstock is admixed with a steam stream to form a pre-reforming admixture and the pre-reforming admixture is passed to a pre-reforming zone for the partial conversion of the pre-treated feedstock to a pre-reformed stream comprising hydrogen, carbon monoxide, carbon dioxide, and unconverted hydrocarbons. The steam can be supplied by the indirect heating of water with process heat from heat recovered in the water gas shift reaction or from heat recovered from flue gas resulting from the combustion of anode waste gas. Preferably the steam is supplied by heating water with the heat recovered from the water gas shift reaction zone. Preferably, the steam to carbon ratio of the pre-reforming admixture is between about 1:1 and about 6:1, and more preferably, the steam to carbon ratio of the pre-reforming admixture is between about 1:1 and about 3: 1, and most preferably, the steam to carbon ratio of the pre-reforming admixture comprises about 2:1. The pre-reforming zone contains a pre-reforming catalyst comprising a catalyst base such as alumina with a metal deposited thereon. Preferably, the pre-reforming catalyst includes nickel with amounts of noble metal, such as cobalt, platinum, palladium, rhodium, ruthenium, iridium, and a support such as magnesia, magnesium aluminate, alumina, silica, zirconia, singly or in combination. More preferably, the steam reforming catalyst can be a single metal such as nickel or a noble metal supported on a refractory carrier such as magnesia, magnesium aluminate, alumina, silica, or zirconia, singly or in combination, promoted by an alkali metal such as potassium. The pre-reforming catalyst can be granular and is supported within the steam reforming zone, The pre-reforming catalyst may be disposed in a fixed bed or disposed on tubes or plates within the pre-reforming zone. In the process of the present invention, the pre-reforming zone is operated at effective pre-reforming conditions including a pre-reforming temperature of between about 300° and about 700° C. and a pre-reforming pressure of between about 100 and about 350 kPa. More preferably, the pre-reforming temperature ranges between about 350° and about 600° C., and most preferably the pre-reforming temperature comprises a temperature between about 3500 and about 550° C. The pre-reforming reaction is an endothermic reaction and requires heat be provided to initiate and maintain the reaction.

In the present invention, the pre-reforming zone is in intimate thermal contact with a first heat exchange zone which transfers heat by indirect heat exchange to the pre-reforming zone. The first heat exchange zone is heated by the passage of a burner exhaust stream or flue gas stream from a burner zone. It is an important aspect of the invention that the burner exit temperature of the burner exhaust stream not exceed about 750° C. so that the heat transfer to the pre-reforming zone occur by convection rather than by radiation. In this way, although there will be some loss of overall thermal efficiency, the first heat exchange zone can be constructed of a material such as stainless steel or carbon steel and thereby avoid the use of exotic, high cost metallurgy in the pre-reformer zone. In order to maintain the burner exit temperature below 750° C., the amount, or the rate, of the air stream passed to the burner zone is controlled In this way the burner exit temperature sets the maximum hot side temperature for the first heat transfer zone and maintains the hot side temperature of the first heat exchange zone at a relatively constant level following the startup of the hydrogen generation section and thereby avoids setting up a thermal cycle in the first heat exchanger and maintaining an essentially steady-state temperature profile within the first heat exchanger. As used herein the term steady-state means that the temperature profile is characterized by a lack of temperature transients Also, by maintaining the burner exit temperature below the radiant heat transfer region, the use of expensive, sophisticated oxygen sensors and related controls and radiation shielding can be avoided.

The pre-reformed stream is passed at effective partial oxidation conditions to a partial oxidation zone wherein the pre-reformed stream is contacted with an oxygen-containing stream, or first air stream, in the presence of a partial oxidation catalyst to produce a partial oxidation product. If the pre-reformed stream is not at effective partial oxidation conditions, such as during the startup of the fuel processor when there is insufficient fuel for the burner zone to heat the pre-reforming zone, the pre-reformed stream and the oxygen-containing stream are ignited to begin the partial oxidation reaction in the partial oxidation zone. The partial oxidation product comprises hydrogen, carbon monoxide, carbon dioxide and some unconverted hydrocarbons. The partial oxidation catalyst is disposed in the partial oxidation zone as a fixed bed.

Catalyst compositions suitable for use in the catalytic partial oxidation of hydrocarbons are known in the art (See U.S. Pat. No. 4,691,071, which is hereby incorporated by reference) Preferred catalysts for use in the process of the present invention comprise as the catalytically active component, a metal selected from Group VIII noble metal, a Group IVA metal and a Group IA or IIA metal of the Periodic Table of the Elements composited on a metal oxide support, wherein the support comprises a cerium-containing alumina. The alumina can be alpha-alumina, or a mixture of alpha-alumina and theta-alumina. Preferably the cerium is present in the amount of about 0.01 to about 5.0% by weight of the support. Preferably, the Group VIII noble metal in the partial oxidation catalyst is a noble metal selected from the group consisting of platinum, palladium, and rhodium. Preferably, the Group IVA metal which is present on the partial oxidation catalyst is selected from the group consisting of germanium, lead, and tin and the Group IVA metal is present in an amount of from about 0.01% to about 5% by weight of the partial oxidation catalyst. Preferably, the Group IA or Group IIA metal is present in the partial oxidation catalyst is selected from the group consisting of sodium, potassium, lithium, rubidium, cesium, beryllium, magnesium, calcium, francium, radium, strontium, and barium and the Group IA or Group IIA metal is present in an amount in the range of from about 0.01% to about 10% by weight of the partial oxidation catalyst. The catalytically active metal may also be supported on suitable carrier materials well known in the art, including the refractory oxides, such as silica, alumina, titania, zirconia and mixtures thereof. Preferably, the partial oxidation catalyst is granular and is supported as a fixed catalyst bed within the partial oxidation zone. In the process of the present invention, the partial oxidation zone is operated at effective partial oxidation conditions including a partial oxidation temperature of below about 1400° C. and a low partial oxidation pressure of between about 100 and about 350 kPa. More preferably, the partial oxidation temperature ranges between about 5000 and about 1400° C., and most preferably the partial oxidation temperature is between about 6000 and about 1100° C.

In one embodiment of the present invention, the partial oxidation reaction zone is positioned in close proximity to a steam reforming zone so that the heat contained in the products of the exothermic partial oxidation reaction rather than being recovered is employed directly to deliver the partial oxidation effluent stream to the steam reforming zone at effective steam reforming conditions and to partially maintain the steam reforming reaction zone at effective steam reforming conditions. In addition, the combined partial oxidation/steam reforming reaction zone links the exothermic partial oxidation zone with the endothermic steam reforming reaction zone to provide thermal compensation for the high temperatures generated in the partial oxidation zone. The steam reforming zone provides internal cooling of the walls of the combined reactor zone thus permitting the use of carbon steel and stainless steel metallurgy rather than exotic metallurgy in a combined partial oxidation zone/steam reforming zone. After starting up the combined partial oxidation/steam reforming reactor arrangement, there is a need to switch from a partial oxidation mode towards a steam reforming mode of operation by reducing the air rate to the partial oxidation zone and by providing heat to the steam reforming zone. In the one embodiment of the present invention, additional heat is supplied by the indirect heat exchange with the above mentioned burner exhaust stream, or flue gas stream, so that during the operation of the combined partial oxidation/steam reforming reactor zone, the proportion of the conversion taking place in the partial oxidation zone is shifted in favor of the steam reforming zone. Preferably the flue gas temperature ranges from about 400° to about 800° C. This shift occurs as the increasing anode waste gas supply and improving heating value permit the operation of the burner zone to provide heat to the steam reforming zone and the pre-reforming zone. The heating value or heating quality of the anode waste gas improves as the concentration of hydrogen in the anode waste gas increases. In this manner the overall efficiency of the fuel processor can advance from the 77 percent energy efficiency of the partial oxidation reaction toward the 87 percent energy efficiency of the steam reforming reaction. In this manner, the combined reactor system of the present invention approaches the higher efficiency of the steam reforming operation, without the slow thermal and conversion response of the steam reforming zone. By overall efficiency it is meant the percent efficiency as determined from the net heating value of the hydrogen in the product hydrogen gas divided by the net heating value of the feedstock. Once the system has reached operating temperatures, that is the burner exit temperature and the steam reforming temperatures approach 750° C. and more preferably 700° C., these operating temperatures are maintained to retain the essentially steady-state temperature profile in the first and the second heat exchanger zones and the variations in demand for electrical power are met by switching between the partial oxidation and the steam reforming reactions and by adjusting the flow of the hydrocarbon feedstock to the pre-processing, or preparation, module.

The use of partial oxidation provides improved start-up performance although it reduces the overall efficiency of the operation Steam reforming on the other hand is slow to start up and operates at a much higher overall efficiency. The combination of the partial oxidation, the reforming, and the pre-reforming zones as provided by the present invention are especially useful in controlling and tolerating the fluctuations in the fuel rate as the demand for electrical power varies. Furthermore, the scheme employs a low complexity control system which is able to handle the variations in fuel flow rate and in fuel quality simultaneously.

The partial oxidation product is passed to the steam reforming zone containing a steam reforming catalyst to produce a reforming effluent stream. Preferably, the steam reforming catalyst includes nickel with amounts of noble metal, such as cobalt, platinum, palladium, rhodium, ruthenium, iridium, and a support such as magnesia, magnesium aluminate, alumina, silica, zirconia, singly or in combination. More preferably, the steam reforming catalyst can be a single metal such as nickel or a noble metal supported on a refractory carrier such as magnesia, magnesium aluminate, alumina, silica, or zirconia, singly or in combination, promoted by an alkali metal such as potassium. Most preferably, the steam reforming catalyst comprises nickel supported on alumina and promoted by an alkali metal such as potassium. The steam reforming catalyst can be granular and is supported as a fixed catalyst bed within the steam reforming zone. In the process of the present invention, the steam reforming zone is operated at effective reforming conditions including a reforming temperature of below about 700° C. and a reforming pressure of between about 100 and about 350 kPa. More preferably, the reforming temperature ranges between about 3500 and about 700° C., and most preferably the reforming temperature is between about 550° and about 650° C. The reforming effluent stream is withdrawn from the reforming zone at a reforming exit temperature of below about 700° C. The reforming exit temperature is maintained at a value of about 700° C. by controlling the rate of the supply of the oxygen-containing stream to the partial oxidation zone. In this manner, the reforming exit temperature establishes the hot side temperature for a second heat exchange zone which will be employed to remove heat from a water gas shift reaction zone.

The reforming effluent is passed to at least one water gas shift reaction zone which exothermically reacts the carbon monoxide over a shift catalyst in the presence of an excess amount of water to produce additional amounts of carbon dioxide and hydrogen. The following is a description of a two-zone water gas shift reaction zone, although any number of water gas shift reaction zones may be employed to reduce the carbon monoxide level in the H₂ product. The steam reforming effluent is combined with water and cooled to an effective high temperature shift temperature of between about 400° and about 450° C. to provide a cooled steam reforming effluent. The cooled steam reforming effluent is passed over a high temperature shift catalyst to produce a high temperature shift effluent. The high temperature shift catalyst is selected from the group consisting of iron oxide, chromic oxide, and mixtures thereof. The high temperature shift effluent is cooled to reduce the temperature of the high temperature shift effluent to a temperature of between about 180° and about 220° C. to effective conditions for a low temperature shift reaction and to provide a cooled high temperature shift effluent. The cooled high temperature shift effluent is passed to a low temperature shift zone and contacted with a low temperature shift catalyst to further reduce the carbon monoxide and produce a low temperature shift effluent. The low temperature shift catalyst comprises cupric oxide (CuO) and zinc oxide (ZnO). Other types of low temperature shift catalysts include copper supported on other transition metal oxides such as zirconia, zinc supported on transition metal oxides or refractory supports such as silica or alumina, supported platinum, supported rhenium, supported palladium, supported rhodium, and supported gold. The low temperature shift reaction is a highly exothenmic reaction and a portion of the heat of the low temperature shift reaction is removed by indirect heat exchange in a second heat exchange zone with a water stream to produce a steam stream. The steam stream is admixed with the treated hydrocarbon feedstock to further conserve thermal energy and provide steam to the pre-reforming zone. The water gas shift effluent stream or hydrogen product comprises less than about 0.5 mol-% carbon monoxide.

Because carbon monoxide acts as a poison to some fuel cells like the PEM fuel cell, the carbon monoxide concentration in the hydrogen product must be removed, or its concentration reduced for example by oxidation, conversion, or separation, before the hydrogen product can be used in these fuel cells to produce electricity. Options for post-processing of the hydrogen product stream to further reduce the carbon monoxide content include selective catalytic oxidation and methanation. In addition, some fuel cells operate at different levels of hydrogen consumption per pass, or hydrogen efficiencies. For example, some fuel cell arrangements demand high purity hydrogen and consume more than about 80% of the hydrogen per pass, while others consume less than about 70% of the hydrogen per pass and do not require high purity hydrogen. In a case which requires high purity, the hydrogen product stream is passed to a separation zone comprising a thermal swing adsorption system or a pressure swing adsorption system to produce a high purity hydrogen stream (95 to 99.999 mol-% hydrogen) and a separation waste stream comprising carbon oxides. A portion of the high purity hydrogen stream may be used in the hydrodesulfurization zone and the remaining portion of the high purity hydrogen stream is passed to the fuel cell zone. Anode waste gas, along with the separation waste steam is passed to the burner zone. For non-fuel cell applications, the use of the anode waste gas can be substituted with a fuel gas stream such as a waste gas stream from a hydrogen purification system like a pressure swing adsorption process.

For fuel cells such as PEM fuel cells which are sensitive to carbon monoxide, the hydrogen product is passed to a carbon oxide oxidation zone at effective oxidation conditions and contacted with a selective oxidation catalyst to produce a carbon oxide reduced hydrogen product gas stream comprising less than about 40 ppm-mole carbon monoxide. Preferably, the carbon oxide reduced hydrogen product gas stream comprises less than about 10 ppm-mole carbon monoxide, and more preferably, the carbon oxide reduced hydrogen product gas stream comprises less than about 1 ppm-mole carbon monoxide. The heat of oxidation produced in the carbon monoxide oxidation zone is removed in a conventional manner by cooling the carbon monoxide oxidation zone in a convention means such as with a water jacket and a cooling water stream.

For a PEM fuel cell, the carbon oxide reduced hydrogen product gas comprising water at saturation and at a temperature less than about 100° C. is passed to the anode side of a fuel cell zone comprising at least one proton exchange membrane (PEM). The PEM membrane has an anode side and a cathode side, and is equipped with electrical conductors which remove electrical energy produced by the fuel cell when an oxygen containing stream is contacted with the cathode side of the PEM membrane. It is required that the PEM membrane be kept from drying out by maintaining the carbon oxide reduced hydrogen product stream at saturation conditions. It is also critical that the PEM membrane be maintained at a temperature less than 100° C. When the PEM membrane is operated to be only about 70 percent efficient in its use of the hydrogen product stream, the fuel cell produces an anode waste gas comprising hydrogen and a cathode waste gas comprising oxygen. Typically, anode waste gas comprises hydrogen, nitrogen, and carbon dioxide. The anode waste gas produced by the present invention comprises less than about 50 mol-% hydrogen, and the cathode waste gas comprises less than about 15 mol-% oxygen.

A second oxygen-containing gas such as air and the anode waste gas withdrawn from the fuel cell anode side are contacted in the burner zone mentioned hereinabove at effective combustion conditions to maintain a burner exit temperature less than about 750° C., and more preferably less than about 700° C. In this manner, the hydrogen generated by the partial oxidation or steam reforming reaction zones and not consumed by the fuel cell is burned to provide thermal integration of the overall process, and in the same burning step any nitrogen introduced by the use of the partial oxidation zone is thereby rejected.

In the scheme of the present invention, at a steady state operation there is no provision to add heat to the reforming step, and the degree of partial oxidation remains essentially constant. The scheme is much more efficient than a fully autothermal process because the heat from the burner zone is used to provide heat to the steam reforming reaction which raises the overall efficiency of the process. The use of the burner zone in intimate thermal contact with the reforming zone as employed in this scheme allows significantly more heat recovery in the pre-reforming operation than if heat were only recovered from the reaction products. Other schemes in the prior art only use heat recovery from the reaction products, such schemes are most often practiced in large-scale plants The large-scale plants do not have an anode waste gas stream to employ as fuel In addition, the process of the present invention permits the use of less exotic metals which significantly reduces the capital cost of the key process equipment.

In the present invention when applied to fuel cell systems, only the anode waste gas is used as fuel, no methane is added and therefore no complex fuel balancing is required to manage fluctuations in fuel quality and anode waste gas production. Anode waste gas composition will vary both in amount and in heat capacity as the efficiency and demand for electricity in the fuel cell change. The air flow to the burner zone is controlled to compensate for the variations in the anode waste gas composition and thereby achieve a constant burner exit temperature of the flue gas withdrawn from the burner. Thus, as the amount of heat available from the anode waste gas is reduced, reducing the heat available to the pre-reformer, there is a corresponding increase in the air demand or rate delivered to the partial oxidation zone to provide additional heat to the system. In the partial oxidation zone a control scheme is provided to control the outlet temperature of the reformer by varying the amount of the second air stream that is introduced to the partial oxidation zone. In this way, the steam reforming outlet, or effluent temperature is maintained essentially at a constant value. If the amount of anode waste gas decreases, the process begins to operate as an autothermal reforming process and the efficiency approaches about 77 percent. If the anode waste gas heat content or amount increases the amount of partial oxidation is reduced. When the degree of partial oxidation is reduced, the overall process approaches a steam reforming operation which has efficiency range between 85 and 87 percent.

Thermal variations in the overall system are minimized to achieve a steady operation by the use of two independent burner control systems. By controlling the exit temperatures of the burner zone and the reforming zone in this manner, variations in the fuel rate are compensated for automatically to provide an essentially steady-state temperature profile in the first and second heat exchange zones which eliminates thermal cycling within the individual heat exchange zones. In addition, the heat available to the pre-reforming zone, the partial oxidation, and the reforming zone always achieve the same overall hydrocarbon conversion. Controlling the temperature at the outlet of the reforming zone to a temperature of about 700° C. of permits the use of less exotic metallurgy in the construction of the partial oxidation and reforming zones and the coupling of the partial oxidation and steam reforming zones to any heat exchange zone is not required.

One of the problems in developing hydrogen generation in small-scale reforming systems is the elimination of thermal cycling of the vessels. Such cycling can result in thermal stresses which lead to fatigue fractures at the welds. Variations in turndown rate, fuel rate, and fuel quality in prior art systems often resulted in a thermal cycling throughout the system. The control system of the present invention maintains the hot side temperature profile in each of the major heat exchange zones at an essentially constant value after startup and thereby avoids any significant variation which would produce thermal cycling in the heat exchange zones. The cold side temperatures in the present system are set by the feed temperature. Thus, thermal cycling and the resulting damage from thermal stresses to heat exchanger zones are effectively limited and an essentially uniform thermal profile is maintained within the heat exchanger zones. A feature of the process redistributes the heat transfer and reaction zones to employ heat exchange between streams with relatively low thermal, or enthalpy, contents relative to the amount of heat generated or consumed in the reaction zones. Variations in flow rates are controlled before these flow variations can impact the equipment and create temperature swings in the reaction zones Thereby, temperature fluctuations in the heat exchanger zones are avoided. Furthermore, the present technique of the controlling hot side temperatures in a range which permits the use of less exotic metallurgy while responding to fluctuations in electrical demand yields significant capital cost advantages with a minimal loss of overall energy efficiency.

According to the present invention, an air stream enters the process through a preliminary compressor The air stream passes through a bed of adsorbent. The adsorbent is selective for the adsorption of nitrogen, consequently the adsorption effluent that leaves the adsorbent bed is substantially enriched in oxygen relative to the air stream. The adsorption effluent gas can be used as an oxygen-enriched stream, or can be combined with additional air to form a stream of higher flow rate that is also enriched in oxygen relative to air. A first portion of the adsorption effluent gas can be used to provide oxidant to the partial oxidation step of the process. The remainder of the oxygen-enriched stream can be either sent directly to the fuel cell cathode, or can be mixed with air to produce an enriched air stream that is sent to the fuel cell cathode.

When the adsorbent bed is substantially saturated with nitrogen it can be regenerated by any means well known in the art such as reducing the pressure (pressure swing adsorption or PSA) or by increasing the temperature (temperature swing adsorption or TSA) of the bed or a combination of PSA and TSA. At least two or more such beds are employed so that a constant flow rate of oxygen can be maintained by cycling the flow between the beds. Preferably the adsorption process is a PSA system and the regeneration is accomplished by employing a vacuum using a second compressor. The two compressors may be housed on the same shaft and driven by the same motor, as is well understood by those skilled in the art.

The oxygen-depleted air stream that is produced as the desorption effluent during regeneration of the adsorbent can also be beneficially used in the process, and this use provides an unexpected benefit. The desorption effluent stream can be used as an oxidant for the anode waste gas; that is, the process waste gas that is formed at the fuel cell anode. Since the desorption effluent stream is rich in nitrogen, its use as an oxidant stream has the effect of reducing the amount of excess air required in the combustion zone providing heat to precondition the feed stream. In this manner, the overall air consumption of the process and the feed compressor capacity is reduced.

Another benefit of the present invention is that use of the adsorption process allows production of an adsorption effluent stream which can range from oxygen-enriched air having an oxygen content of from about 35 to 99.9 mol-% oxygen. Using the oxygen-enriched stream significantly improves the performance of the fuel cell by increasing the efficiency of the electrochemical reactions and increasing the driving forces for those reactions in the PEM fuel cell.

A further advantage of the present invention is that the oxygen-enriched stream can be used in the partial oxidation reaction zone and the preferential oxidation zone to produce additional hydrogen and reduce carbon monoxide in the hydrogen fuel stream passed to the fuel cell mode. The use of oxygen-enriched streams in the partial and preferential oxidation reactions reduces the amount of nitrogen that is introduced to the process, and provides increased hydrogen purity in the hydrogen fuel stream which improves fuel cell performance. Reducing the nitrogen flowing through the process also improves the efficiency of process heat transfer within the process and reduces the amount of partial oxidation that is needed, consequently further raising the process efficiency.

Another unexpected benefit of this arrangement is that the desorption effluent stream produced when the adsorbent is regenerated can be used as oxidant in combusting anode waste gas as long as the oxygen concentration in this gas is sufficient to reach the desired flue gas temperature (about 7000 to 750° C.). This corresponds to a minimum oxygen concentration of about between about 5 to 15 mol-%, which is surprisingly consistent with oxygen concentration present in the desorption effluent stream. When this off gas is used as oxidant in the anode combustion zone, then the amount of excess air is substantially reduced, which reduces the overall flow of air to the plant. The pressure drop on the flue gas side is also reduced. Both to the reduction in the flow of air and the reduced combustion zone pressure drop combine to produce a reduction in the size and cost of the process main air compressor, or blower.

### DETAILED DESCRIPTION OF THE DRAWING

Referring to the Drawing, a feed stream in line 1 is passed to a fuel processor zone 104. An air stream in line 10 is passed to a first adsorption zone 101 of at least two adsorption zones (101,102). Each of the adsorption zones contain a nitrogen selective adsorbent for the selective adsorption of nitrogen from the air stream to produce during an adsorption step and adsorption effluent enriched in oxygen relative to the air stream. The adsorption effluent in line 12 is withdrawn from the first adsorption zone 101 and a first portion is passed to a partial oxidation zone in the fuel processor zone 104 via line 14. A second portion of the adsorption effluent in line 14 is passed to a cathode side C of a fuel cell zone 106 via line 16. In the fuel cell zone 106, a fuel steam comprising hydrogen in line 18 is withdrawn from the fuel processor 104 and passed to the anode side A of the fuel cell zone 106 to produce electric power and a cathode waste gas stream in line 22 and an anode waste gas stream in line 20 are generated. The anode waste gas stream in line 20 comprises hydrogen and the cathode waste gas stream in line 22 is depleted in oxygen. The anode waste gas stream in line 20, at least a portion of the cathode waste gas in line 22, and at least a portion of a desorption effluent in line 24 withdrawn from a second adsorption zone 102 undergoing a desorption step are passed to a combustion zone 108 and therein combusted to provide heat (shown as line 26) for a conversion zone in the fuel processor zone 104. By alternating the first adsorption zone 101 and the second adsorption zone 102 between the adsorption step and the desorption step, a continuous supply of the oxygen-enriched gas stream is available for the fuel processor zone 104 and the fuel cell zone 106, and a continuous supply of the desorption effluent stream in line 24 is available for use in the combustion zone to maintain the combustion temperature in the convection range, i.e., a combustion zone temperature of less than or equal to about 750° C. Preferably, a minimum oxygen concentration of about 5 to about 15 mol-% is required to achieve this combustion temperature. More preferably, the concentration of the desorption effluent stream comprises a minimum of about 12 mol-% oxygen and a maximum of about 15 mol-% oxygen. The regeneration or desorption of the second adsorption zone can be accomplished by any means known to those skilled in the art of adsorptive separation including pressure swing adsorption, temperature swing adsorption, vacuum swing adsorption and combinations thereof One mechanical means of obtaining a further benefit which is not shown in the process flow drawing is the use of a blower, or preliminary compressor to raise the pressure of the air stream in line 10 to an effective adsorption pressure, a first compressor between line 12 and line 14 to raise the pressure of the adsorption effluent to an effective partial oxidation pressure or an effective preferential oxidation pressure, and a second compressor between the second adsorption zone 102 and line 24 to supply the desorption effluent stream to the combustion zone 108 at an effective combustion pressure. A portion of the air stream 10, shown herein as 10′ may be admixed with the desorption effluent stream in line 24 prior to passing the desorption effluent stream to the combustion zone 108 to maintain a minimum oxygen concentration of about 12 mol-% in the desorption effluent stream. The blower, the first compressor and the second compressor can operate independently or can be housed on the same shaft and driven by the same motor. Such motor-compressor arrangements are well-known to those skilled in the art.

The following examples were prepared from engineering simulations based on pilot plant performance of a fuel processor and a fuel cell to illustrate the operation of a fuel processor employing a combination of steam reforming and partial oxidation reactions as described hereinabove and show the advantage of the present invention over the prior art.

### EXAMPLES

### Example 1

To illustrate the effect of oxygen enrichment on partial oxidation reactor performance, Table 1 presents the composition of a reformate produced from a natural gas feed in an autothermal reformer comprising a partial oxidation reactor followed by secondary reforming reactor with an outlet temperature ranging between about 600° to 700° C. In case (a) the partial oxidation reactor feed comprises steam, methane, and air; and, in case (b) the partial oxidation reactor feed comprises steam, methane, and pure oxygen. The concentration of hydrogen in the reformate is about 35% higher in case (b) with pure oxygen compared to case (a) wherein the partial oxidation reactor feed included air. The reformate from either case (a) or case (b) will be processed further in a water gas shift zone and a preferential oxidation zone to produce a fuel stream having a CO concentration less than about 50 ppm. It is well known that increased hydrogen purity in the fuel stream passed to the fuel cell will result in improved fuel cell performance. Because the nitrogen in the air stream is not a reactant in the partial oxidation reaction, any amount of oxygen enrichment in the feed to the partial oxidation reaction zone will result in increased hydrogen purity in the fuel stream produced.

TABLE 1

| Composition (mol-%) | Case (a) | Case (b) |
|---|---|---|
| CH₄ | 0.011 | 0.023 |
| CO | 0.070 | 0.095 |
| CO₂ | 0.073 | 0.091 |
| H₂ | 0.378 | 0.510 |
| H₂O | 0.218 | 0.281 |
| O₂ | 0.000 | 0.000 |
| N₂ | 0.250 | 0.000 |

### Example 2

The performance of a fuel cell with enriched oxygen vs. air is well understood by practitioners of the art. For example, in U.S. Pat. No. 6,106,963 to Nitta et al, the fuel cell voltage and power density are illustrated as a function of the current density for three cases corresponding to cathode side feed streams including air and two oxygen enriched gases As the oxygen content of the cathode side feed stream is enriched, the maximum power density produced in the fuel cell is clearly shown to increase.

### Example 3

Case (a) of Table 2 shows the performance of a fuel processor/fuel cell system wherein the anode waste gas stream produced by the fuel cell is combusted in a combustion zone which is maintained at a temperature of about 650° C. by mixing the anode waste gas with an excess air stream prior to combustion. In case (a), the fuel cell is operated at twice the stoichiometric ratio of oxygen at the cathode side of the fuel cell and the fuel cell consumes about 70% of the hydrogen in the reformate at the anode side. In case (a) the anode waste gas is combusted in an excess amount of air to provide a constant flue gas temperature of 650° C. In case (b), the fuel cell is run at twice the stoichiometric ratio of oxygen in the cathode and consumes about 70% of the hydrogen in the reformate at the anode. The anode waste gas is combusted with a portion of the cathode waste gas to provide a constant flue gas temperature of 650° C.

TABLE 2

| | Case (a) | Case (b) |
|---|---|---|
| Cathode feed flowrate (kmol/hr) | 1.10 | 1.10 |
| Fresh air to burner flowrate (kmol/hr) | 0.97 | 0.0 |
| Cathode air blower power (W) | 59.1 | 59.1 |
| Burner air blower power (W) | 63.4 | 0.0 |
| Total air blower power (W) | 122.5 | 59.1 |

The parasitic power consumption in case (b) for the air blowers using oxygen-depleted air as the oxidant to combust the anode waste gas is thus reduced by 52% over case (a) which is based on using air in excess to maintain the combustion zone temperature at about 650° C.

We claim:

1. A process for the generation of electricity from a fuel cell, said process comprising:
a) passing a fuel stream admixed with a first oxygen-enriched stream to a conversion zone comprising a partial oxidation reactor and therein converting at least a portion of the fuel stream to provide a reformate stream comprising hydrogen;
b) passing the reformate stream to an anode side of a fuel cell zone, having a cathode side and the anode side and passing a second oxygen-enriched stream to the cathode side to produce electricity and withdrawing an anode waste gas stream and a cathode waste gas stream;
c) combusting at least a portion of the anode waste gas stream in the presence of an oxygen-depleted stream in a combustion zone to produce a flue gas stream at a combustion zone temperature to at least partially heat the conversion zone;
d) passing an air stream to a first adsorption bed in an adsorption zone comprising at least two adsorption beds, said adsorption beds containing a nitrogen selective adsorbent, wherein said first bed undergoes an adsorption step to provide an adsorption effluent stream and at least a portion of the adsorption effluent stream provides said first and second oxygen-enriched streams;
e) regenerating at least one other adsorption bed in said adsorption zone to provide a desorption effluent stream; and
f) passing at least a portion of the desorption effluent stream to the combustion zone as the oxygen-depleted stream to maintain said combustion zone less than about 700° C.

2. The process of claim 1 wherein the conversion zone comprises a steam reforming zone and said fuel stream comprises steam.

3. The process of claim 1 wherein the regenerating step is selected from the group consisting of pressure swing adsorption, thermal swing adsorption, vacuum swing adsorption and mixtures thereof.

4. The process of claim 1 wherein the reformate comprises carbon monoxide and the conversion zone includes a water gas shift reactor containing at least one water gas shift zone to convert at least a portion of the carbon monoxide in the presence of water to carbon dioxide and hydrogen.

5. The process of claim 1 wherein the conversion zone comprises a preferential oxidation zone to oxidize carbon monoxide to carbon dioxide and said process further comprises passing a portion of the adsorption effluent stream to the preferential oxidation zone.

6. The process of claim 1 further comprising admixing a feed stream comprising a hydrocarbon or an oxygenate with a steam stream to provide a feed admixture and passing the feed admixture to a pre-reforming zone and simultaneously indirectly heating the pre-reforming zone with at least a portion of said flue gas stream and recovering a pre-reformed stream comprising hydrogen, carbon monoxide, carbon dioxide, and water and passing the pre-reformed stream to the conversion zone as the fuel stream.

7. The process of claim 1 further comprising compressing the air stream prior to step (d).

8. The process of claim 1 further comprising compressing the air stream prior to step (d) and compressing the adsorption effluent stream prior to providing the first and the second oxygen-enriched streams.

9. The process of claim 8 further comprising compressing the desorption effluent stream prior to passing the portion of the desorption effluent stream to the combustion zone.

10. The process of claim 1 wherein the fuel stream comprises light hydrocarbons selected from the group consisting of methane, ethane, propane, butanes and mixtures thereof.

11. The process of claim 1 wherein the fuel stream comprises oxygenates selected from the group consisting of alcohols, ethers, ketones, esters, and mixtures thereof.

12. The process of claim 1 further comprising indirectly heat exchanging at least a portion of the flue gas stream with a water stream to provide a steam stream.

13. The process of claim 1 further comprising admixing a portion of the air stream with the oxygen-depleted stream prior to step (c).

14. A process for the generation of electricity from a fuel cell, said process comprising:
a) admixing a steam stream with a feed stream to provide a feed admixture and passing the feed admixture to a pre-reforming zone in indirect contact with a first heat exchange zone to adjust the feed admixture to effective pre-reforming conditions and to at least partially convert the feed stream to a pre-reformed stream comprising hydrogen, carbon monoxide, carbon dioxide, and water;
b) passing the pre-reformed stream and a first oxygen-enriched stream to a conversion zone comprising a partial oxidation zone and a steam reforming zone to convert at least a portion of the pre-reformed stream to provide a reformate stream enriched in hydrogen relative to the pre-reformed stream comprising hydrogen, carbon monoxide, carbon dioxide, and water;
c) passing the reformate stream to an anode side of a fuel cell zone, having a cathode side and the anode side and passing a second oxygen-enriched stream to the cathode side to generate electricity and withdrawing an anode waste gas from the anode side and a cathode waste gas from the cathode side;
d) passing an air stream to a first adsorption zone of at least two adsorption zones, each of said adsorption zones containing a nitrogen selective adsorbent, and withdrawing an adsorbent effluent stream enriched in oxygen relative to the air stream;
e) passing a first portion of the adsorption effluent stream to the conversion zone as the first oxygen-enriched stream and passing a second portion of the adsorption effluent stream to the fuel cell zone as the second oxygen-enriched stream;
f) combusting at least a portion of the anode waste gas stream and an oxygen-depleted stream in a combustion zone to indirectly supply heat to the conversion zone; and
g) regenerating a second adsorption zone to remove previously adsorbed nitrogen to provide a desorption effluent stream depleted in oxygen relative to the air stream and passing at least a portion of the desorption effluent stream to the combustion zone as the oxygen-depleted stream.

15. A process for the enrichment of air supplied to an integrated fuel processor and fuel cell system comprising a fuel processor zone and a fuel cell zone, said process comprising:
a) passing an air stream in an adsorption step to a first adsorbent bed of at least two adsorbent beds, each of said adsorbent beds containing a nitrogen selective adsorbent to adsorb nitrogen and recovering an adsorption effluent enriched in oxygen relative to the air stream;
b) passing a first portion of the adsorption effluent stream to a partial oxidation zone of the integrated fuel processor and fuel cell system to produce a fuel stream comprising hydrogen;
c) passing a second portion of the adsorption effluent stream to a cathode fuel cell zone having an anode side and the cathode side and recovering a cathode waste gas stream;
d) passing the fuel stream to the anode side of the fuel cell zone to convert the fuel stream to electric power and recovering an anode waste gas comprising hydrogen being depleted in hydrogen relative to the fuel stream;
e) desorbing a second adsorbent bed in a desorption step, said second adsorbent bed comprising previously adsorbed nitrogen to provide a desorption effluent enriched in nitrogen;
f) combusting the desorption effluent and at least a portion of the anode waste gas stream in a combustion zone to produce a flue gas stream at a combustion temperature less than about 650° C. to indirectly provide heat to the fuel processor zone; and
g) alternating the first and second adsorbent beds between the adsorption and desorption steps to provide a continuous process.

16. The process of claim 15 wherein the desorption effluent stream comprises more than about 12 mol-% oxygen.
